(19) United States
(12) Patent Application Publication
(10) Pub. No.: US 2013/0149119 A1
(43) Pub. Date: Jun. 13, 2013

(54) VARIABLE CAPACITY CORE TYPE HEAT EXCHANGER UNIT

(71) Applicant: Jungmin SEO, Ansan-si (KR)

(72) Inventor: Jungmin SEO, Ansan-si (KR)

(73) Assignee: Hyundai Motor Company, Seoul (KR)

(21) Appl. No.: 13/486,771

(22) Filed: Jun. 1, 2012

(30) Foreign Application Priority Data
Dec. 9, 2011 (KR) 10-2011-0131536

(51) Int. Cl. F28D 15/00; F04D 29/00; G05D 23/00

(52) U.S. Cl. 415/175; 165/104.33; 165/287

(57) ABSTRACT

A variable capacity core type heat exchanger unit, may include a heat exchanger heat-exchanging high-temperature cooling water, a reservoir tank in which the high-temperature cooling water is inputted and thereafter, transmitted to the heat exchanger and the low-temperature cooling water is inputted and thereafter, discharged to the engine and the electric system, wherein the reservoir tank includes an introduction space and a discharge space, and an actuator module installed to the reservoir tank and controlled by a controller, varying the introduction space through which the high-temperature cooling water is inputted into the heat exchanger and the discharge space through which the low-temperature cooling water is discharged from the heat exchanger, wherein the variation in the introduction space is associated with the variation in the discharge space.

### CROSS-REFERENCE TO RELATED APPLICATIONS

The present application claims priority to Korean Patent Application Number 10-2011-0131536 filed Dec. 9, 2011, the entire contents of which application is incorporated herein for all purposes by this reference.

### BACKGROUND OF THE INVENTION

1. Field of the Invention

The present invention relates to a heat exchanger, and more particularly, to a variable capacity core type heat exchanger unit that rapidly supplies more low-temperature cooling water quantity to a heat exchange core taking charge of an engine or an electric system requiring a rapid cooling operation , thereby increasing heat exchange performance of the heat exchange core significantly.

2. Description of Related Art

In general, a cooling system of a gasoline vehicle requires an engine radiator for cooling an engine and a condenser for cooling refrigerant of an air-conditioner, while a hybrid vehicle further requires an electric system radiator for cooling electric products in addition thereto.

In general, the engine radiator, the condenser, and the electric system radiator are called a heat exchanger.

In particular, a cooling water temperature of approximately 95° C. is maintained to cool diesel and gas engines adopted in a commercial vehicle in terms of the cooling system, while a cooling water temperature of 50° C. or less should be maintained in hybrid constituent components such as a motor and an inverter.

Therefore, the cooling system of the hybrid vehicle further includes the electric system radiator as described above, such that the performance of the cooling system can be smoothly implemented even at a cooling water temperature which is maintained to be relatively lower than the gasoline engine.

FIG. 6 shows an example of a layout of the cooling system of the hybrid vehicle.

FIG. 6A shows an engine radiator 400 installed in an engine room 300 and FIG. 6B shows an electric system radiator 600 installed in a compartment 500 partitioned by additional partitions in the same engine room 300.

As described above, in the cooling system of the hybrid vehicle, the engine radiator and the electric system radiator are configured as separate systems or even though the engine radiator and the electric system radiator are integrally configured, the engine radiator and the electric system radiator are partitioned by the partition and the flow of the cooling water in the core is also separated.

By this configuration, even though the cooling water temperature is maintained to be relatively low as in the hybrid vehicle, the performance of the engine radiator and the electric system radiator can be maintained according to the relatively low cooling water temperature.

However, in engine radiator 400 and electric system radiator 600 which are configured separately, cooling fans are also separately required, such that a cost is increased due to the addition of the cooling fan and additional power cannot but be required to drive two cooling fans.

The additional power for driving two cooling fans consequently deteriorates a fuel efficiency improvement effect of the hybrid vehicle and additional control logic for improving fuel efficiency should be developed in order to compensate for the deterioration in the fuel efficiency.

In particular, engine radiator 400 and electric system radiator 600 are integrally configured, such that additional space for engine radiator 400 and electric system radiator 600 should be provided in engine room 300 which has almost no spare space, and as a result, the engine room of the hybrid vehicle cannot but have a relatively smaller spare space than that of the gasoline vehicle.

The short spare space of the engine room cannot but restrain a layout of the engine room and the restraint in layout of the engine room cannot but be contrary to a tendency toward ensuring a vehicle room space which is further expanded and a tendency toward decreasing an engine room package for ensuring a low-speed collision (RCAR) grade.

When the engine room package cannot be decreased, various devices and apparatuses cannot be installed in the space of the engine room, and as a result, in particular, merchantable quality of a compact hybrid vehicle may be more disadvantageous.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable capacity core type heat exchanger unit capable of rapidly increasing the quantity of supplied low-temperature cooling water that can implement a cooling action by dividing introduction spaces where a high-temperature cooling water is inputted into an engine radiator and an electric system radiator which are integrated with each other by using a movement plate and moving the movement plate so as to preferentially increase a high-temperature cooling water quantity inputted into a core at the radiator side requiring high cooling performance.

Further, Various aspects of the present invention are directed to providing a variable capacity core type heat exchanger unit in which the engine radiator and the electric system radiator are integrated with each other by using the movement plate to change the high-temperature cooling water quantity, such that it is possible to remove a layout restraint due to two radiators which are separated and to implement an engine room which is more advantageous even in ensuring a low collision (RCAR) grade.

In an aspect of the present invention, a variable capacity core type heat exchanger unit, may include a heat exchanger heat-exchanging high-temperature cooling water discharged from each of an engine and an electric system and changing the high-temperature cooling water into low-temperature cooling water and configured by a core sending the low-temperature cooling water to each of the engine and the electric system; a reservoir tank in which the high-temperature cooling water is inputted and thereafter, transmitted to the heat exchanger and the low-temperature cooling water is inputted and thereafter, discharged to the engine and the electric system, wherein the reservoir tank includes an introduction space and a discharge space; and an actuator module installed to the reservoir tank and controlled by a controller, varying the introduction space through which the high-temperature cooling water is inputted into the heat exchanger and the discharge space through which the low-temperature cooling water is discharged from the heat exchanger, wherein the variation in the introduction space is associated with the variation in the discharge space.

The heat exchanger may include an engine heat dissipating core with a section where the high-temperature cooling water discharged from the engine is inputted to flow therein and thereafter, discharged, and an electric system heat dissipating core with a section where the high-temperature cooling water discharged from the electric system is inputted to flow in and thereafter, discharged, wherein the reservoir tank may include a left reservoir tank sending the high-temperature cooling water discharged from each of the engine and the electric system, to the engine heat dissipating core and the electric system heat dissipating core, wherein the left reservoir tank is divided into a first introduction space and a second introduction space by a first actuator module, and a right reservoir tank sending the low-temperature cooling water discharged from the engine heat dissipating core and the electric system heat dissipating core to each of the engine and the electric system, wherein the right reservoir tank is divided into a first discharge space and a second discharge space by a second actuator module, and wherein the first actuator module that varies the first and second introduction spaces where the high-temperature cooling water discharged from each of the engine and the electric system is inputted into the left reservoir tank respectively, and wherein the second actuator module that varies the first and second discharge spaces where the low-temperature cooling water discharged from each of the engine heat dissipating core and the electric system heat dissipating core is discharged respectively.

The engine heat dissipating core and the electric system heat dissipating core may have sizes to bisect a whole size of the heat exchanger.

The engine heat dissipating core and the electric system heat dissipating core are arranged to be adjacent to each other in parallel to each other so that the flow of cooling water is horizontal therein and the left reservoir tank and the right reservoir tank are coupled to both left and right portions of the engine dissipating core and the electric system heat dissipating core, respectively.

The engine heat dissipating core and the electric system heat dissipating core may have sizes to bisect a whole size of the heat exchanger.

The engine heat dissipating core and the electric system heat dissipating core are arranged to be overlapped with each other vertically to each other so that the flow of the cooling water is vertical therein and the left reservoir tank and the right reservoir tank are coupled to an upper portion and a lower portion of the engine heat dissipating core and the electric system heat dissipating core, respectively.

The engine heat dissipating core and the electric system heat dissipating core may have sizes to bisect a whole size of the heat exchanger.

The actuator module may include a motor generating power, a rotational mechanism embedded in a housing block coupled with the motor and rotating through the motor, a movable mechanism which is distant from the motor or close to the motor according to a rotational direction of the rotational mechanism, and a partition plate fixed to the movable mechanism and varying the introduction space and the discharge space while moving together in a movement direction of the movable mechanism.

The first actuator module may include a first motor generating power, a first rotational mechanism embedded in a housing block coupled with the motor and rotating through the first motor, a first movable mechanism which is distant from the first motor or close to the first motor according to a rotational direction of the first rotational mechanism, and a first partition plate fixed to the first movable mechanism and disposed between the first and second introduction spaces of the left reservoir tank and movable in a movement direction of the first movable mechanism, wherein the second actuator module may include a second motor generating power, a second rotational mechanism embedded in a housing block coupled with the second motor and rotating through the second motor, a second movable mechanism which is distant from the second motor or close to the second motor according to a rotational direction of the second rotational mechanism, and a second partition plate fixed to the second movable mechanism and disposed between the first and second discharge spaces of the right reservoir tank and movable in a movement direction of the second movable mechanism, and wherein the first partition plate and second partition plate are associated with each other by the controller.

A resolver sensor detecting a movement distance of the movable mechanism and transmitting the detection signal to the controller is embedded in the motor.

The rotational mechanism may include an output shaft supported on the housing block and freely rotating by receiving rotational force of the motor, and a guide shaft arranged in parallel to the output shaft and fixed to the housing block, and wherein the movable mechanism may include a feed block coupled to the output shaft and performing linear movement to be distant from the motor or close to the motor according to a rotational direction of the output shaft, and a partition block moving together in a movement direction of the feed block to move the partition plate.

The output shaft and the feed block are screw-coupled to each other and the guide shaft and the partition block are spline-coupled to each other.

The feed block and the partition block engage with each other.

A support shaft fixed to the housing block is further arranged in the rotational mechanism to be parallel to the guide shaft and a guide block guiding the movement of the partition block while moving together in the movement direction of the partition block is further provided in the movable mechanism.

The partition block and the guide block engage with each other.

The controller may further include control logic in which a cooling water temperature of the engine and a cooling water temperature of the electric system are considered and the actuator module is controlled based on a difference in the cooling water temperatures.

The control logic implements feedback-control of the actuator module with a signal of a resolver sensor provided in the actuator module.

According to an exemplary embodiment of the present invention, the engine radiator and the electric system radiator are integrated with each other by using a movement wall moved to change the high-temperature cooling water quantity, such that it is possible to remove a layout restraint due to two radiators which are separated and to implement an engine room which is more advantageous even in ensuring a low collision (RCAR) grade, and particularly, a radiator requiring high cooling performance can be preferentially cooled concentratively.

Further, according to the exemplary embodiment of the present invention, the required high-temperature cooling water quantity is varied according to conditions of the engine radiator and the electric system radiator, such that a whole area of the core is decreased by approximately 20% as compared with two independent radiators under the same performance or an area size of the engine radiator is increased by approximately 117% and simultaneously, an area size of the electric system radiator can be increased by approximately 137%, under the same size.

In addition, according to the exemplary embodiment of the present invention, the engine radiator and the electric system radiator which are integrated into one adopts only one cooling fan, such that a cost is decreased due to a decrease in the number of cooling fans and fuel efficiency is improved due to a decrease in consumed power by approximately 40% and addition of additional control logic is not required.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a configuration diagram of a variable capacity core type heat exchanger unit according to an exemplary embodiment of the present invention.

FIG. 2 is a configuration diagram of an actuator of the heat exchanger unit according to the exemplary embodiment of the present invention.

FIG. 3 is an operational diagram of the variable capacity core type heat exchanger unit according to the exemplary embodiment of the present invention.

FIG. 4 is a diagram showing a change of a layout of the variable capacity core type heat exchanger unit according to the exemplary embodiment of the present invention.

FIG. 5 is an operational diagram of the variable capacity core type heat exchanger unit according to the exemplary embodiment of the present invention having the changed layout.

FIG. 6 is a layout of a cooling system of a hybrid vehicle in the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be hereinafter described in detail with reference to the accompanying drawings.

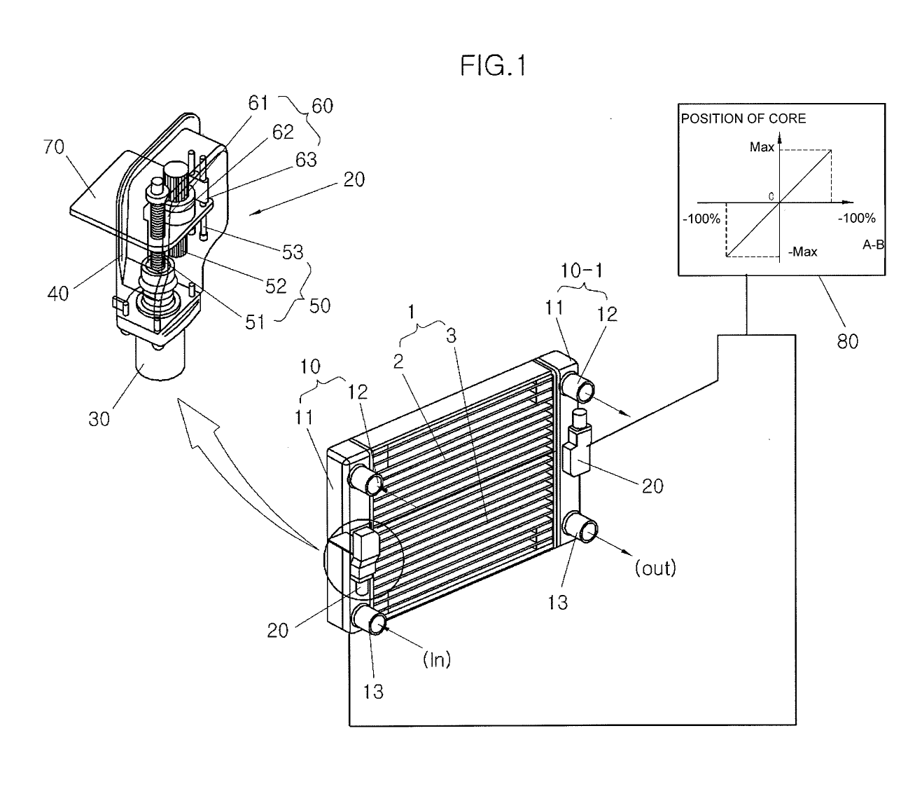

Referring to FIG. 1, a heat exchanger unit includes a heat exchanger 1 in which a core heat-exchanging high-temperature cooling water with the outside to switch the high-temperature cooling water into low-temperature cooling water is divided into at least two sections, a left reservoir tank 10 into which the high-temperature cooling water is inputted on a left surface portion of heat exchanger 1, a right reservoir tank 10-1 into which the low-temperature cooling water of which the temperature decreases after passing through heat exchanger 1 is inputted on a right surface portion of heat exchanger 1, and an actuator module 20 changing the sizes of the divided two sections of heat exchanger 1 by a control of a controller 80.

Heat exchanger 1 includes an engine heat dissipating core 2 taking charge of cooling an engine and an electric system heat dissipating core 3 taking charge of cooling an electric system. Engine heat dissipating core 2 and electric system heat dissipating core 3 are integrally configured to be formed by two sections divided so that the high-temperature cooling water flows.

Engine heat dissipating core 2 serves to heat-exchange the high-temperature cooling water with the outside so that the high-temperature cooling water discharged from the engine is switched to the low-temperature cooling water to be sent to the engine again and electric system heat dissipating core 3 serves to heat-exchange the high-temperature cooling water with the outside so that the high-temperature cooling water discharged from the electric system is switched to the low-temperature cooling water to be sent to the electric system again.

Engine heat dissipating core 2 and electric system heat dissipating core 3 are formed by a core in which both ends are opened so that the cooling water is introduced into one side and discharged to an opposite side and the core is configured by a core assembly arranged as multilayers linearly.

As heat dissipating pin shape may be further formed in the core so as to increase heat exchange performance of the passing cooling water.

The whole size of heat exchanger 1 is basically configured by engine heat dissipating core 2 of ½ size and electric system heat dissipating core 3 of ½ size.

However, engine heat dissipating core 2 may be configured to be relatively larger than electric system heat dissipating core 3 or vice versa according to a specification of the hybrid vehicle.

Left and right reservoir tanks 10 and 10-1 are manufactured by individual components such as left reservoir tank 10 and right reservoir tank 10-1, respectively.

On the contrary, left and right reservoir tanks 10 and 10-1 have a cavity housing 11 which is an empty space in which the cooling water is filled and a pair of upper and lower nipples 12 and 13 that is in communication with cavity housing 11 and connected with a cooling water line, thereby having the same configuration.

Left reservoir tank 10 serves to send the high-temperature cooling water of the engine to engine heat dissipating core 2 of heat exchanger 1 and send the high-temperature cooling water of the electric system to electric system heat dissipating core 3 of heat exchanger 1.

To this end, there is provided a layout in which upper nipple 12 of left reservoir tank 10 is connected with a cooling water discharging line of the engine and lower nipple 13 is connected with a cooling water discharging line of the electric system.

Right reservoir tank 10-1 serves to send the low-temperature cooling water cooled in the engine heat dissipating core 2 to the engine again and send the low-temperature cooling water cooled in electric system heat dissipating core 3 to the electric system again.

To this end, there is provided a layout in which upper nipple 12 of right reservoir tank 10-1 is connected with a cooling water returning line of the engine and lower nipple 13 is connected with a cooling water returning line of the electric system.

As a result, when left reservoir tank 10 is installed on one side portion of heat exchanger 1, right reservoir tank 10-1 is installed at an opposite side portion.

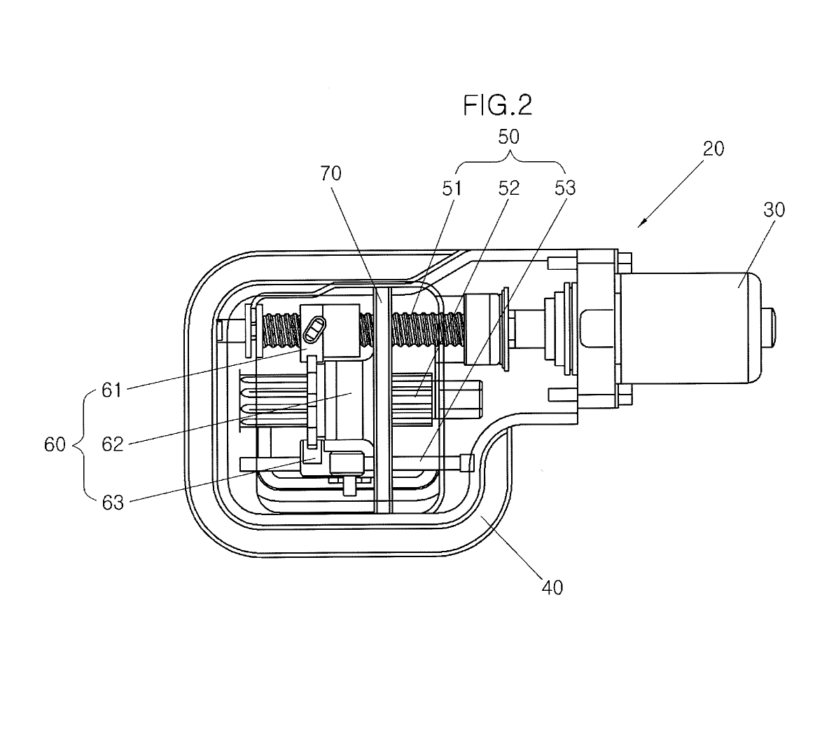

Meanwhile, referring to FIG. 2, actuator module 20 is mounted on left reservoir tank 10 so that the high-temperature cooling water quantities sent to engine heat dissipating core 2 and electric system heat dissipating core 3 are different from each other and mounted on right reservoir tank 10-1 so that the low-temperature cooling water quantities discharged from engine heat dissipating core 2 and electric system heat dissipating core 3 are also different from each other.

The pair of actuator modules 20 is controlled to interwork with each other and also have the same configuration.

Actuator module 20 includes a motor 30 generating power, a housing block 40 coupling motor 30 and forming an empty space, a rotational mechanism 50 which is embedded in housing block 40 and rotates through motor 30, a movable mechanism 60 which is distant from motor 30 or close to motor 30 according to a rotational direction of rotational mechanism 50, and a partition plate 70 which moves together in a movement direction of movable mechanism 60.

As motor 30, a step motor is adopted, but various motors in which the same operation and effect are implemented may be adopted.

A resolver sensor detecting a movement distance of movable mechanism 60 is embedded in motor 30 and a detection signal of the resolver sensor is transmitted to a controller 80.

Housing block 40 has a wholly sealed structure to be protected from the outside, but a surface where partition plate 70 is exposed is opened to allow partition plate 70 to move.

Therefore, an opening area of housing block 40 is determined according to the movement distance of partition plate 70.

Rotational mechanism 50 includes an output shaft 51 which is connected directly to rotating motor 30 and screw-machined on an outer peripheral surface thereof, a guide shaft 52 which is arranged in parallel to an arrangement direction of output shaft 51, but does not rotate, and a support shaft 53 which is arranged in parallel to an arrangement direction of guide shaft 52, but does not rotate.

A free end portion of output shaft 51 is supported on housing block 40 and as necessary, may be supported through a bearing fixed to housing block 40.

Both ends of guide shaft 52 are fixed by using housing block 40 and a spline is formed on an outer peripheral surface thereof.

Both ends of support shaft 53 are fixed by using housing block 40.

Movable mechanism 60 includes a feed block 61 in which linear movement to be distant from motor 30 or close to motor 30 occurs according to a rotational direction of screw-coupled output shaft 51, a partition block 62 receiving force from feed block 61 to move together in a movement direction of feed block 61, and a guide block 63 guiding stable movement by supporting movement of partition block 62.

A screw is formed on an inner peripheral surface of feed block 61 and the spline is formed on an inner peripheral surface of partition block 62.

Partition block 62 is configured together with partition plate 70 and may be formed integrally with partition plate 70 or screw-coupled with partition plate 70.

A movement distance of partition block 62 is detected by the resolver sensor embedded in motor 30 and the detection signal is transmitted to controller 80.

In movable mechanism 60 configured as above, in terms of a coupling structure, both a coupling structure of feed block 61 and partition block 62 and a coupling structure of partition block 62 and guide block 63 have a structure in which the blocks may engage with each other by using an uneven shape.

To this end, a step protrusion forming a protruding portion is formed in partition block 62 and a step groove is formed in feed block 61 and guide block 63.

As described above, partition block 62 moves in association with feed block 61 that moves linearly through output shaft 51 which is rotated by motor 30 and moreover, is supported in association with guide block 63 coupled to support shaft 53.

Therefore, partition plate 70 may move more stably together with partition block 62.

Meanwhile, controller 80 basically adopts logic to control a vehicle by using various information of the vehicle and furthermore, further includes control logic to vary the cooling water quantity sent to engine heat dissipating core 2 and electric system heat dissipating core 3 by controlling actuator module 20 considering a temperature difference between the cooling water temperature of the engine and the cooling water temperature of the electric system.

The control logic to vary the cooling water quantity is based on the temperature difference between the cooling water temperature of the engine and the cooling water temperature of the electric system and considers the movement distance of partition block 62 or partition plate 70 detected by the resolver sensor and the temperature difference between the cooling water temperature of the engine and the cooling water temperature of the electric system which are detected.

When the control is achieved, controller 80 feedback-controls actuator module 20 and controller 80 may adopt an engine control unit (ECU) or a motor control unit (MCU).

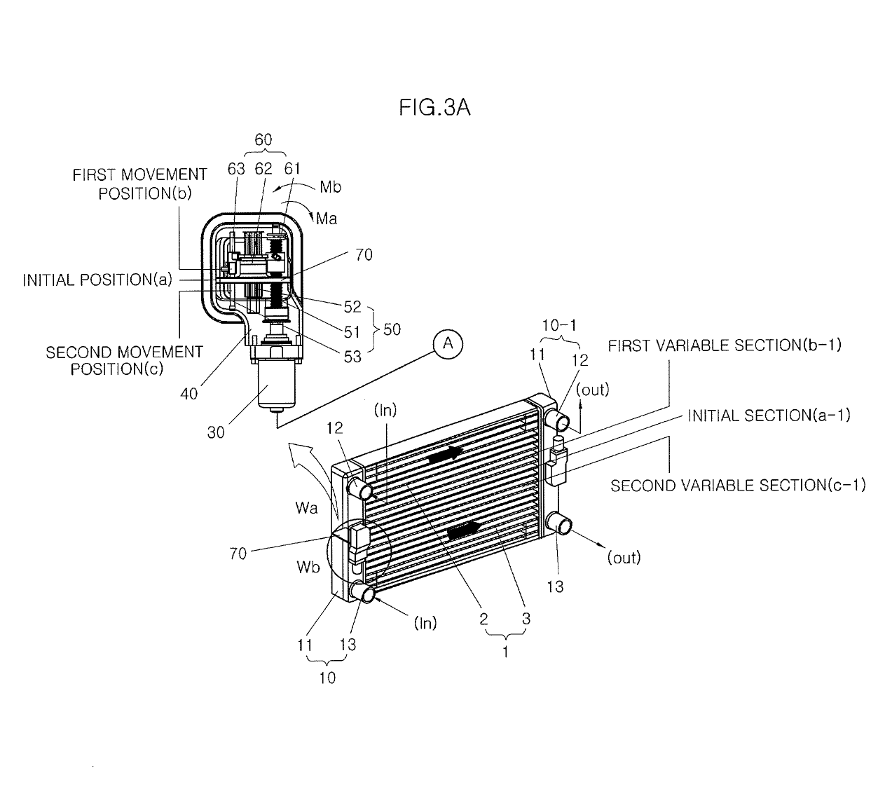

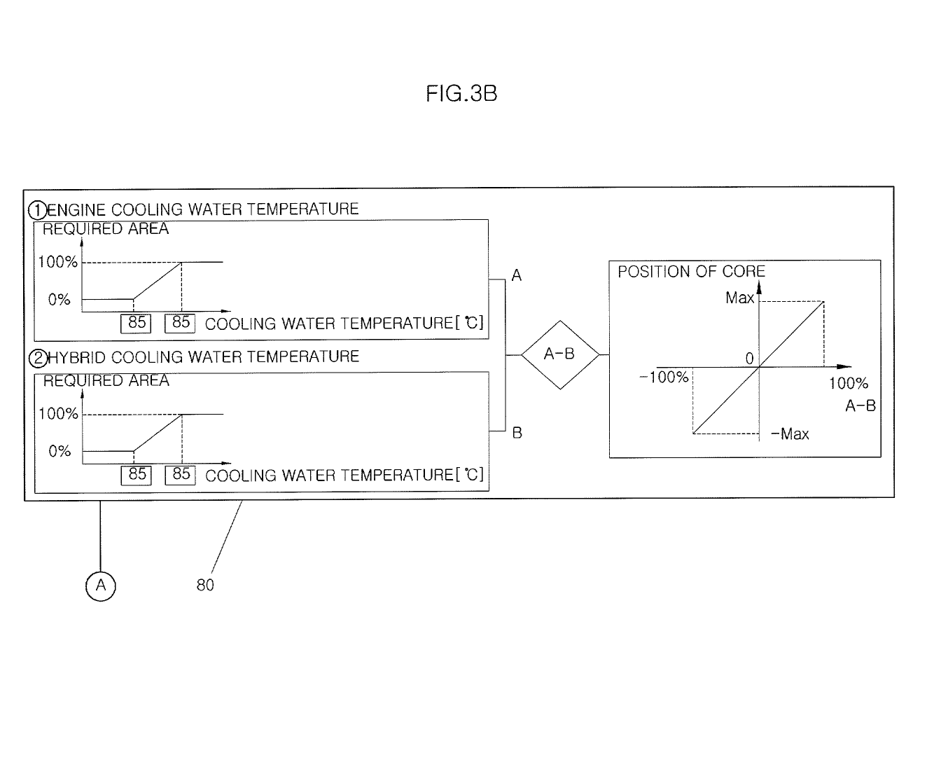

Referring to FIG. 3, in order to drive actuator module 20, controller 80 matches the detected cooling water temperature of the engine and the detected cooling water temperature of the electric system with the respective required area lines and deduces the high-temperature cooling water quantity of the engine inputted into engine heat dissipating core 2 and the high-temperature cooling water quantity of the electric system inputted into electric system heat dissipating core 3 according to the matching result. Thereafter, the result is converted into an output signal to be transmitted to actuator module 20.

In this process, the high-temperature cooling water quantity of the engine and the high-temperature cooling water quantity of the electric system are determined as a rate for each quantity.

For example, when the capacity of heat exchanger 1 is 100%, each of engine heat dissipating core 2 and electric system heat dissipating core 3 is defined as 50%.

Therefore, when engine heat dissipating core 2 requires a relatively lower heat exchanging action than electric system heat dissipating core 3, the capacity of engine heat dissipating core 2 is changed to 30%, while the capacity of electric system heat dissipating core 3 is changed to 70%.

Subsequently, when the output signal discharged from controller 80 is transferred to actuator module 20, output shaft 51 connected thereto rotates together with motor 30 driven (assumed as a clockwise direction) and feed block 61 screw-coupled to output shaft 51 becomes distant from motor 30 by the rotation of output shaft 51.

The aforementioned movement of feed block 61 moves partition block 62 coupled thereto in the same direction and partition plate 70 coupled to partition block 62 is moved in the same direction as partition block 62 by the movement of partition block 62.

Partition block 62 is moved through guide shaft 52 which is spline-coupled to each other and simultaneously, supported through guide block 63 coupled to support shaft 53, and as a result, partition block 62 may be moved more stably.

Partition plate 70 is moved through an opened portion of housing block 40, such that partition plate 70 may be moved without hindrance.

Herein, a movement position of partition plate 70 depending on the movement of partition plate 70 is assumed as a first movement position b from an initial position a, and as a result, it is assumed that the capacity of engine heat dissipating core 2 is decreased to 30%, while the capacity of electric system heat dissipating core 3 is increased to 70%.

The aforementioned movement result of partition plate 70 occurs in a space within a cavity housing 11 of left reservoir tank 10.

Therefore, partition plate 70 moves to a first variable section b-1 from an initial section a-1 in which engine heat dissipating core 2 and electric system heat dissipating core 3 are linked to each other in the space in cavity housing 11.

When partition plate 70 moves from initial section a-1 to first variable section b-1, the space occupied by engine heat dissipating core 2 is decreased in the space in cavity housing 11 of left reservoir tank 10, while the space occupied by electric system heat dissipating core 3 is increased.

Meanwhile, when actuator module 20 mounted on left reservoir tank 10 is driven, actuator module 20 mounted on right reservoir tank 10-1 is also driven.

Therefore, the space in cavity housing 11 is moved from initial section a-1 to first variable section b-1 by driving actuator module 20 mounted on left reservoir tank 10 and simultaneously, the space in cavity housing 11 is moved from initial section a-1 to first variable section b-1 by driving actuator module 20 mounted on right reservoir tank 10-1.

In this case, actuator module 20 of right reservoir tank 10 is operated similarly as actuator module 20 of left reservoir tank 10 and the operation is synchronized by the control of controller 80.

When the spaces in left reservoir tank 10 and right reservoir tank 10-1 are switched from initial section a-1 to first variable section b-1 as described above, the high-temperature cooling water quantity of the engine inputted through upper nipple 12 of left reservoir tank 10 is supplied to engine heat dissipating core 2 while decreased as large as a difference between initial section a-1 and first variable section b-1.

On the contrary, the high-temperature cooling water quantity of the electric system inputted through lower nipple 13 is supplied to electric system heat dissipating core 3 while increased as large as the difference between initial section a-1 and first variable section b-1.

As a result, the quantity of the low-temperature cooling water discharged from engine heat dissipating core 2, which is discharged through upper nipple 12 of right reservoir tank 10-1, is decreased in proportion to a quantity inputted through upper nipple 12 of right reservoir tank 10-1, while the quantity of the low-temperature cooling water discharged from electric system heat dissipating core 3, which is discharged through lower nipple 13 of right reservoir tank 10-1, is increased in proportion to a quantity inputted through lower nipple 13 of right reservoir tank 10-1.

Therefore, the heat exchange performance of the high-temperature cooling water of the engine through engine heat dissipating corer 2 may deteriorate, but the heat exchange performance of the high-temperature cooling water of the electric system through electric system heat dissipating core 3 is further increased.

As a result, it is possible to optimally cope with a heat management situation of the electric system which should be further concentrated than heat management of the engine.

On the contrary, when engine heat dissipating core 2 requires a relatively higher heat exchange action than electric system heat dissipating core 3, controller 80 controls actuator module 20 so that partition plate 70 moves from an initial position a to a second movement position c.

In this process, all the processes are inversely performed when actuator module 20 moves from initial position a to first movement position b.

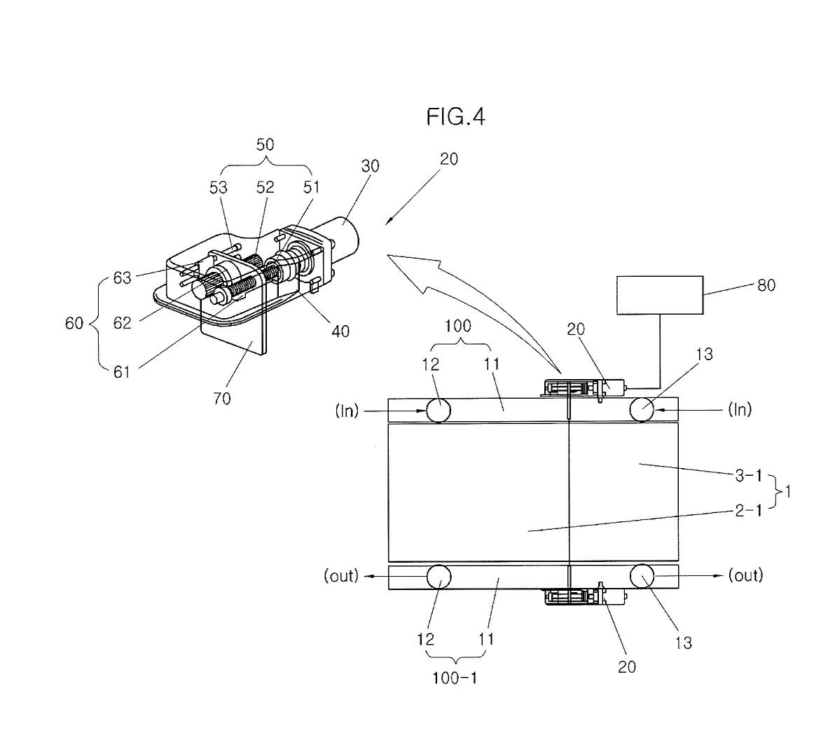

Meanwhile, referring to FIG. 4, it can be seen that a change in a layout of the variable capacity core type heat exchanger unit follows a vertical arrangement structure of an engine heat dissipating core 2-1 and an electric system heat dissipating core 3-1 constituting heat exchanger 1.

That is, an upper reservoir tank 100 is mounted on the top of heat exchanger 1, while a lower reservoir tank 100-1 is mounted on the bottom of heat exchanger 1. Even in this case, the pair of actuator modules 20 controlled by controller 80 is mounted on upper reservoir tank 100 and lower reservoir tank 100-1, respectively.

Herein, upper reservoir tank 100 is just another name of left reservoir tank 10 having the same configuration and lower reservoir tank 100-1 is just another name of right reservoir tank 10-1 having the same configuration.

However, heat exchanger 1 having engine heat dissipating core 2-1 and electric system heat dissipating core 3-1 which have the vertical arrangement structure as described above may also implement the same operation and effect as the above-mentioned horizontal arrangement structure.

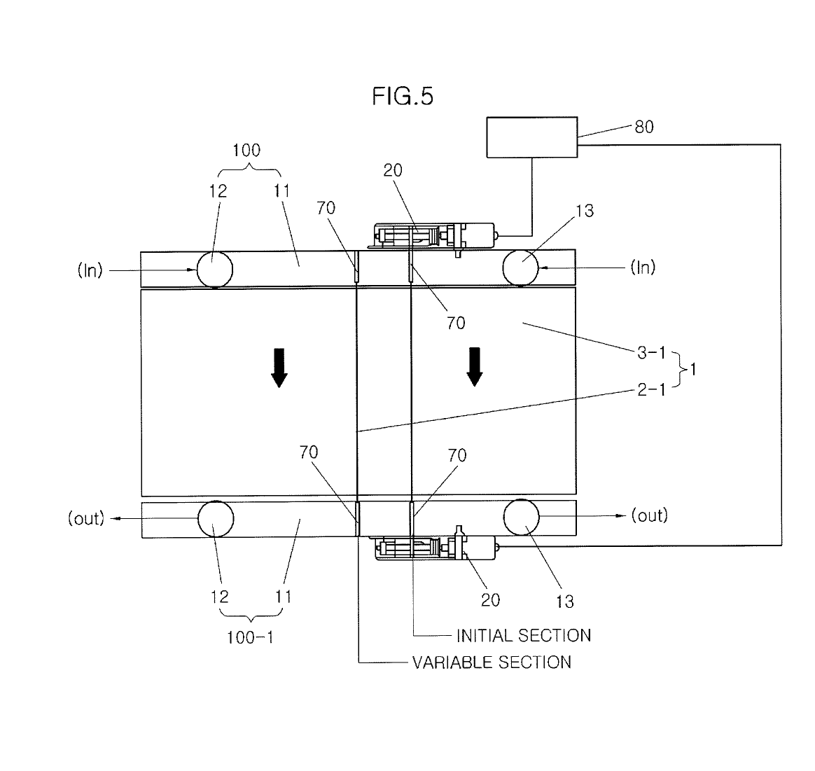

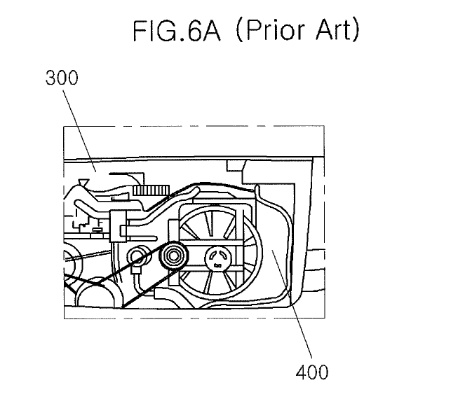

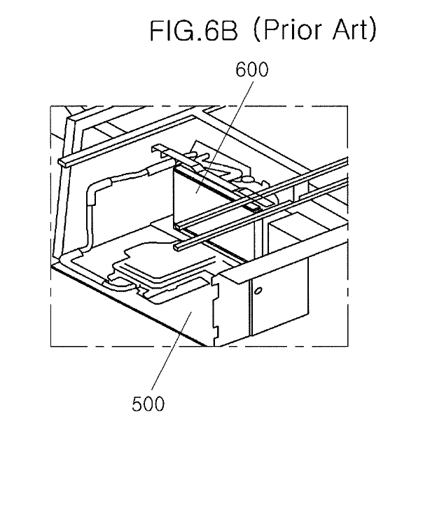

Referring to FIG. 5, it can be seen that even though engine heat dissipating core 2-1 and electric system heat dissipating core 3-1 constituting heat exchanger 1 have the vertical arrangement structure, a cooling ability of each of the cores may be varied.

Therefore, even in this case, partition plate 70 is moved through actuator module 20 controlled by controller 80, and as a result, initial sections of upper reservoir tank 100 and lower reservoir tank 100-1 may be changed to a variable section.

The operation results in controlling the high-temperature cooling water quantity supplied to engine heat dissipating core 2-1 and electric system heat dissipating core 3-1 and it can be seen that this is the same operation and effect as engine heat dissipating core 2 and electric system heat dissipating core 3 which have the horizontal arrangement structure as described above.

As described above, the variable capacity core type heat exchanger unit according to the exemplary embodiment includes heat exchanger 1 in which the engine radiator and the electric system radiator are integrated with each other and actuator module 20 controlled by controller 80 so that the spaces of left and right reservoir tanks 10 and 10-1 into which the high-temperature cooling water is inputted and from which the heat-exchanged low-temperature cooling water is discharged are varied by using partition plate 70.

By this configuration, a target to be firstly cooled can be preferentially concentrated between the engine and the electric system and in particular, as the engine radiator and the electric system radiator are integrated into one heat exchanger 1, the layout restraint is removed and the engine room can be implemented more advantageously even in ensuring the low-speed collision (RCAR) grade.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable capacity core type heat exchanger unit, comprising:
a heat exchanger heat-exchanging high-temperature cooling water discharged from each of an engine and an electric system and changing the high-temperature cooling water into low-temperature cooling water and configured by a core sending the low-temperature cooling water to each of the engine and the electric system;
a reservoir tank in which the high-temperature cooling water is inputted and thereafter, transmitted to the heat exchanger and the low-temperature cooling water is inputted and thereafter, discharged to the engine and the electric system, wherein the reservoir tank includes an introduction space and a discharge space; and
an actuator module installed to the reservoir tank and controlled by a controller, varying the introduction space through which the high-temperature cooling water is inputted into the heat exchanger and the discharge space through which the low-temperature cooling water is discharged from the heat exchanger, wherein the variation in the introduction space is associated with the variation in the discharge space.

2. The variable capacity core type heat exchanger unit as defined in claim 1,
wherein the heat exchanger includes:
an engine heat dissipating core with a section where the high-temperature cooling water discharged from the engine is inputted to flow therein and thereafter, discharged; and
an electric system heat dissipating core with a section where the high-temperature cooling water discharged from the electric system is inputted to flow in and thereafter, discharged,
wherein the reservoir tank includes:
a left reservoir tank sending the high-temperature cooling water discharged from each of the engine and the electric system, to the engine heat dissipating core and the electric system heat dissipating core, wherein the left reservoir tank is divided into a first introduction space and a second introduction space by a first actuator module; and
a right reservoir tank sending the low-temperature cooling water discharged from the engine heat dissipating core and the electric system heat dissipating core to each of the engine and the electric system, wherein the right reservoir tank is divided into a first discharge space and a second discharge space by a second actuator module, and
wherein the first actuator module that varies the first and second introduction spaces where the high-temperature cooling water discharged from each of the engine and the electric system is inputted into the left reservoir tank respectively; and
wherein the second actuator module that varies the first and second discharge spaces where the low-temperature cooling water discharged from each of the engine heat dissipating core and the electric system heat dissipating core is discharged respectively.

3. The variable capacity core type heat exchanger unit as defined in claim 2, wherein the engine heat dissipating core and the electric system heat dissipating core have sizes to bisect a whole size of the heat exchanger.

4. The variable capacity core type heat exchanger unit as defined in claim 2, wherein the engine heat dissipating core and the electric system heat dissipating core are arranged to be adjacent to each other in parallel to each other so that the flow of cooling water is horizontal therein and the left reservoir tank and the right reservoir tank are coupled to both left and right portions of the engine dissipating core and the electric system heat dissipating core, respectively.

5. The variable capacity core type heat exchanger unit as defined in claim 4, wherein the engine heat dissipating core and the electric system heat dissipating core have sizes to bisect a whole size of the heat exchanger.

6. The variable capacity core type heat exchanger unit as defined in claim 2, wherein the engine heat dissipating core and the electric system heat dissipating core are arranged to be overlapped with each other vertically to each other so that the flow of the cooling water is vertical therein and the left reservoir tank and the right reservoir tank are coupled to an upper portion and a lower portion of the engine heat dissipating core and the electric system heat dissipating core, respectively.

7. The variable capacity core type heat exchanger unit as defined in claim 6, wherein the engine heat dissipating core and the electric system heat dissipating core have sizes to bisect a whole size of the heat exchanger.

8. The variable capacity core type heat exchanger unit as defined in claim 1, wherein the actuator module includes:
a motor generating power;
a rotational mechanism embedded in a housing block coupled with the motor and rotating through the motor;
a movable mechanism which is distant from the motor or close to the motor according to a rotational direction of the rotational mechanism; and
a partition plate fixed to the movable mechanism and varying the introduction space and the discharge space while moving together in a movement direction of the movable mechanism.

9. The variable capacity core type heat exchanger unit as defined in claim 2,
wherein the first actuator module includes:
a first motor generating power;
a first rotational mechanism embedded in a housing block coupled with the motor and rotating through the first motor;
a first movable mechanism which is distant from the first motor or close to the first motor according to a rotational direction of the first rotational mechanism; and
a first partition plate fixed to the first movable mechanism and disposed between the first and second introduction spaces of the left reservoir tank and movable in a movement direction of the first movable mechanism;
wherein the second actuator module includes:
a second motor generating power;
a second rotational mechanism embedded in a housing block coupled with the second motor and rotating through the second motor;
a second movable mechanism which is distant from the second motor or close to the second motor according to a rotational direction of the second rotational mechanism; and
a second partition plate fixed to the second movable mechanism and disposed between the first and second discharge spaces of the right reservoir tank and movable in a movement direction of the second movable mechanism, and
wherein the first partition plate and second partition plate are associated with each other by the controller.

10. The variable capacity core type heat exchanger unit as defined in claim 8, wherein a resolver sensor detecting a movement distance of the movable mechanism and transmitting the detection signal to the controller is embedded in the motor.

11. The variable capacity core type heat exchanger unit as defined in claim 10,
wherein the rotational mechanism includes:
an output shaft supported on the housing block and freely rotating by receiving rotational force of the motor; and
a guide shaft arranged in parallel to the output shaft and fixed to the housing block, and
wherein the movable mechanism includes:
a feed block coupled to the output shaft and performing linear movement to be distant from the motor or close to the motor according to a rotational direction of the output shaft; and
a partition block moving together in a movement direction of the feed block to move the partition plate.

12. The variable capacity core type heat exchanger unit as defined in claim 11, wherein the output shaft and the feed block are screw-coupled to each other and the guide shaft and the partition block are spline-coupled to each other.

13. The variable capacity core type heat exchanger unit as defined in claim 11, wherein the feed block and the partition block engage with each other.

14. The variable capacity core type heat exchanger unit as defined in claim 11, wherein a support shaft fixed to the housing block is further arranged in the rotational mechanism to be parallel to the guide shaft and a guide block guiding the movement of the partition block while moving together in the movement direction of the partition block is further provided in the movable mechanism.

15. The variable capacity core type heat exchanger unit as defined in claim 14, wherein the partition block and the guide block engage with each other.

16. The variable capacity core type heat exchanger unit as defined in claim 1, wherein the controller further includes control logic in which a cooling water temperature of the engine and a cooling water temperature of the electric system are considered and the actuator module is controlled based on a difference in the cooling water temperatures.

17. The variable capacity core type heat exchanger unit as defined in claim 16, wherein the control logic implements feedback-control of the actuator module with a signal of a resolver sensor provided in the actuator module.
